(19) United States
(12) Patent Application Publication
(10) Pub. No.: US 2003/0039019 A1
(43) Pub. Date: Feb. 27, 2003

(54) Tuneable liquid crystal optical filter

(76) Inventors: Timothy Large, Cambridge (GB); Mary New, Herts (GB); Allan Carmichael, Herts (GB)

Correspondence Address: Dykema Gossett, 3rd Floor West Franklin Square, 1300 I Street N W, Washington, DC, 20005-3306, US

(21) Appl. No.: 10/169,158

(22) PCT Filed: Dec. 22, 2000
(86) PCT No.: PCT/GB00/05005

(30) Foreign Application Priority Data
Dec. 29, 1999 (GB) 9930762.1

(51) Int. Cl. G02F 1/07; G02F 1/03

(52) U.S. Cl. 359/256; 359/250; 359/252

(57) ABSTRACT

A tuneable optical filter having a variable wavelength transmittance. The filter comprises a pre-polariser, a post-polariser and a birefringent plate positioned between the pre-polariser and the post-polariser. A twisted nematic liquid crystal cell (TN LCD) is positioned between the pre-polariser and the post-polariser, the TN LCD being controlled, in use, to tune the filter. A quarter wave plate is positioned adjacent the birefringent plate.

This invention relates to the field of optical wavelength filtering. The invention provides an optical filter whose colour can be tuned, for example by applying an electronic drive signal to a standard twisted nematic liquid crystal display (TN LCD). When used in combination with a light source, it may be used for visual applications, such as colour adjustable lighting and information display systems. In such applications, it is often desirable to have a single light source which can be electronically adjusted to provide a range of different colours. Examples include display or architectural lighting systems, shop window displays, advertising displays, computer screens and overhead projector systems. High optical transmission is desirable in many such applications.

One known way of providing tuneable colour from a single light source is to spatially divide the light from a white light source into three channels and filter each channel with red, green and blue filters respectively. Re-mixing the light with variable attenuation (for example by using a TN LCD and polarisers as described above) in each channel allows the user to produce a wide variety of colours.

This system is used in colour LCD panels, in which a dye layer is used to mask areas of, or all of, the display. A great range of colours can be produced, but with considerable loss in optical efficiency.

The disadvantages of this type of system are that the transmission of each colour filter is at maximum only 30%, and the means of providing attenuation are also lossy. In the example of a colour LCD, the filter losses combined with polariser losses typically make the overall transmission 10% maximum.

According to the present invention there is provided a tuneable optical filter having a variable wavelength transmittance comprising:

a pre-polariser;

a post-polariser;

a birefringent plate positioned between the pre-polariser and the post-polariser;

a twisted nematic liquid crystal cell (TN LCD) positioned between the pre-polariser and the post-polariser the TN LCD being controlled, in use, to tune the filter; and

a quarter wave plate positioned adjacent the birefringent plate.

A filter according to the invention has a transmission three times that of a conventional colour liquid crystal display. It also utilises standard LCDs and so can be easily manufactured from readily available low cost components.

One of the pre-polariser and the post-polariser may have its polarising axis inclined at substantially 45° to the optical axis of the birefringent plate. A second TN LCD may be provided such that either birefringent plate is positioned between the TN LCDs or the two TN LCDs are positioned in series.

The pre-polariser may comprise at least one sheet of dielectric material configured as either a straight plate, a “V” shape or a series of adjacent “V” shapes. In each case the angles of portions of the at least one sheet are inclined at the Brewster angle to the incoming light. The pre-polariser may comprise a dichroic polariser and it may be a heat resistant pre-polariser.

The birefringent plate may be a two wave plate. At least one of the group of pre-polariser and post-polariser may be wavelength independent and the birefringent sheet may be wavelength independent in terms of amplitude modulation.

A lighting system may be provided, which comprises a light source and an optical filter as previously defined. The lighting system may further comprise a colour selection means and the light source may be attached to a heat resistant pre-polariser to form a removable, disposable, self contained unit. The lighting system may further comprise a photocell which receives light from the light source and converts this light to energy, to drive the optical filter.

The ability to produce wavelength selectivity using a normally wavelength independent TN LCD allows a simple and low cost tunable optical filter. Because the filter is tuneable the efficiency of the filter is enhanced over conventional three colour LCD displays, being three times more efficient. Low power consumption and solid state operation lead to higher levels of reliability and the potential for remote operation and powering from ambient or local external light sources.

Examples of the present invention will now be described with reference to the accompanying drawings, in which:

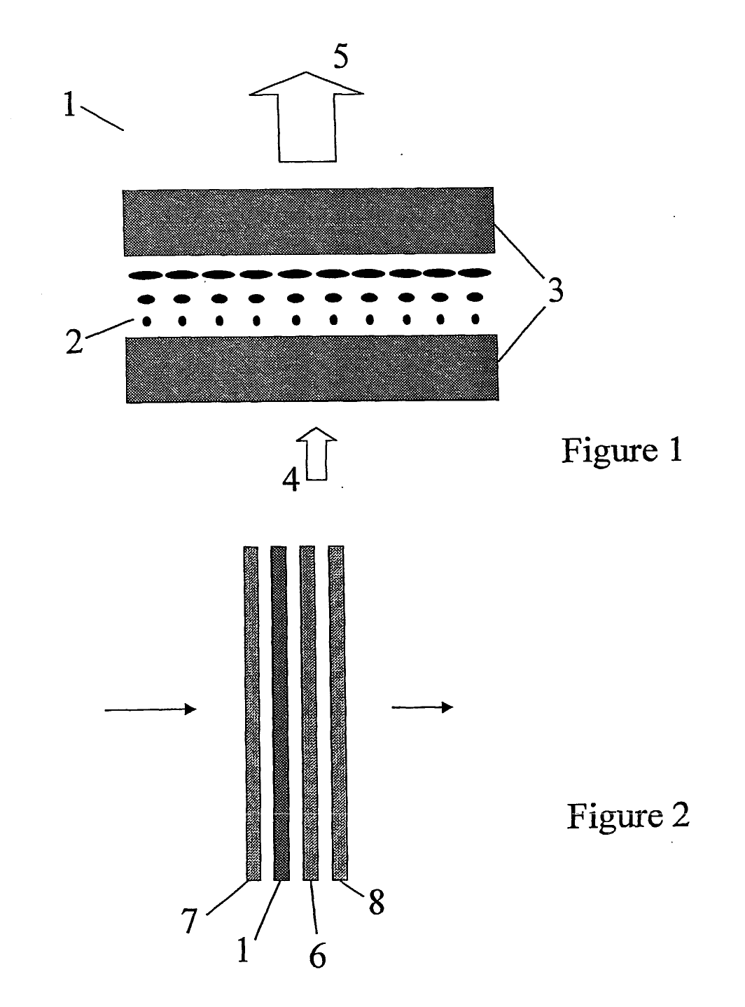

FIG. 1 is a schematic diagram of a twisted nematic liquid crystal display (TN LCD);

FIG. 2 is a schematic diagram of an example filter;

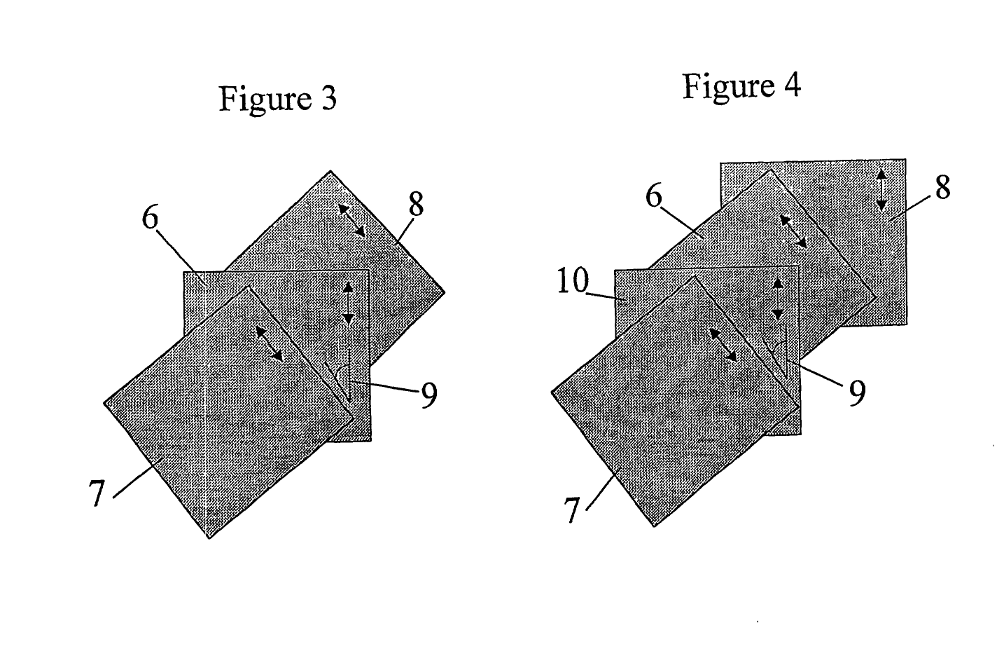

FIG. 3 is a schematic diagram illustrating the orientation of the components of the filter of FIG. 2;

FIG. 4 shows a filter incorporating a quarter wave birefringent plate in accordance with the present invention;

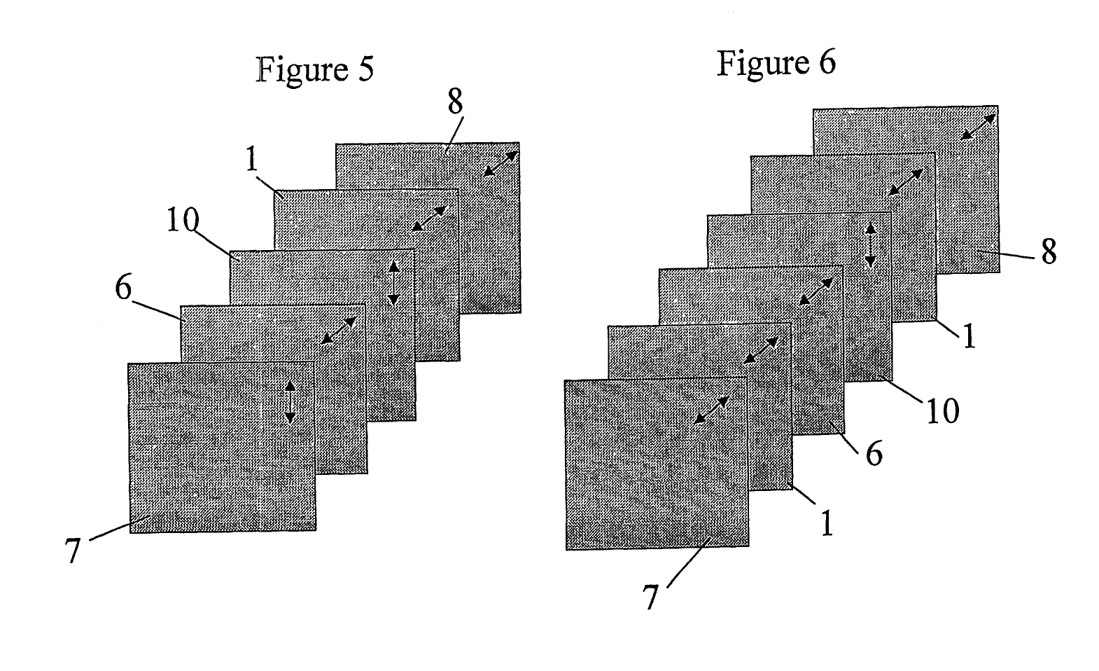

FIGS. 5 and 6 show further example filters of the invention with two TN LCDs;

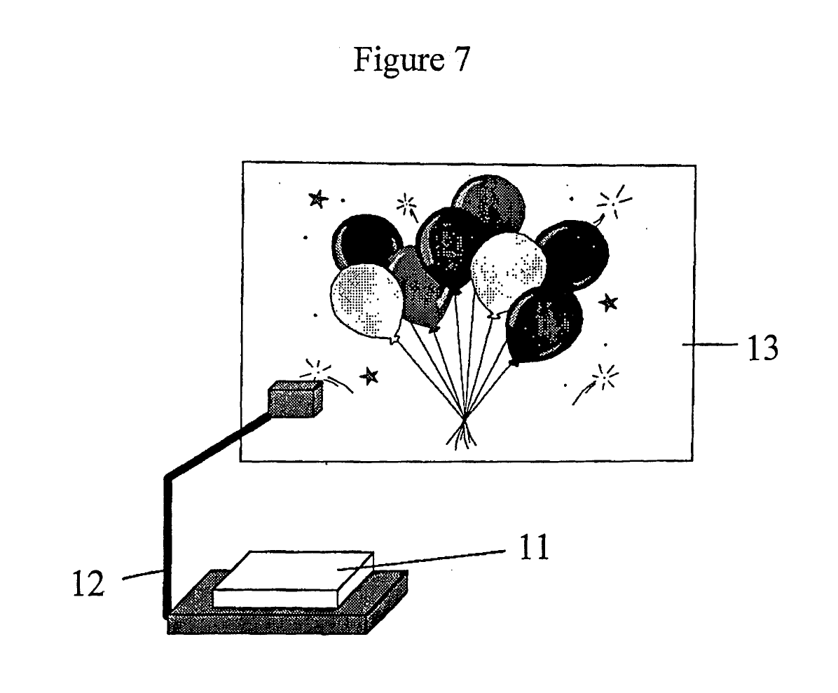

FIG. 7 illustrates a typical application of the filter of the present invention;

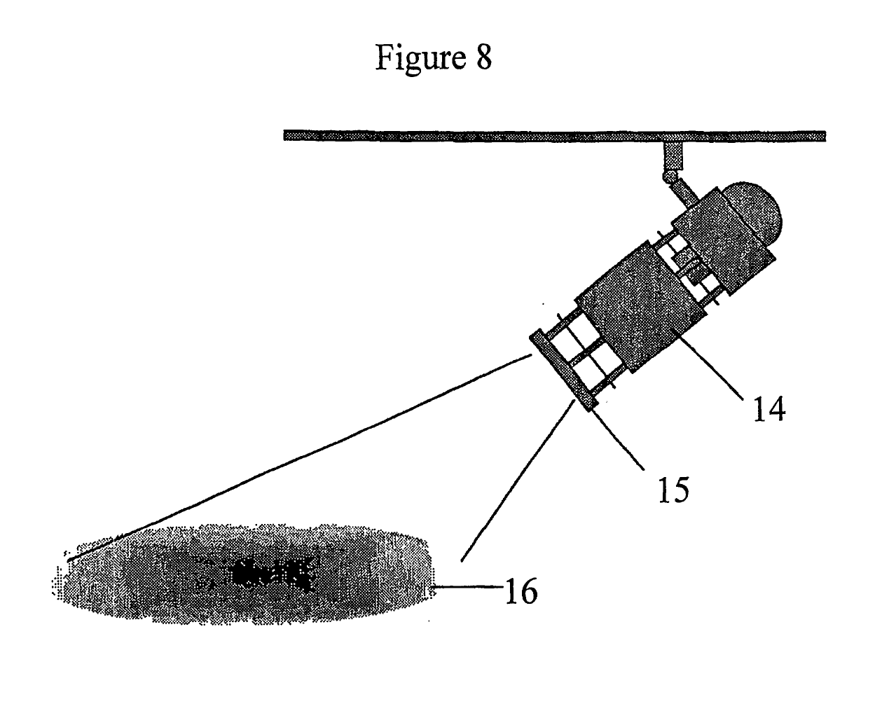

FIG. 8 illustrates a further application of the filter of the present invention;

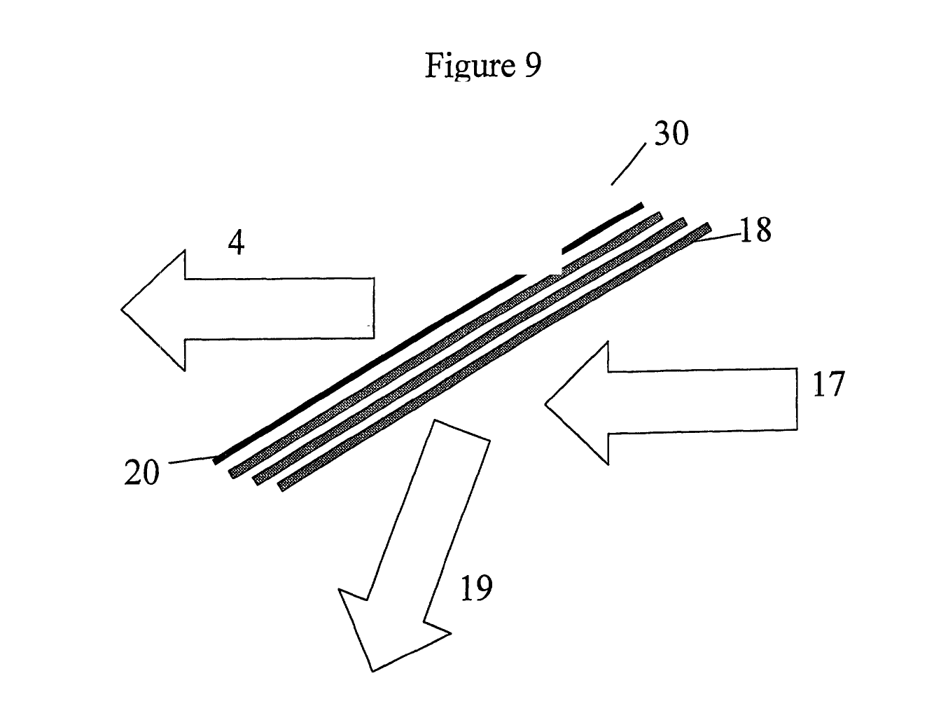

FIG. 9 is a schematic diagram which illustrates how light of unwanted polarisation may be diverted from the filter of earlier figures;

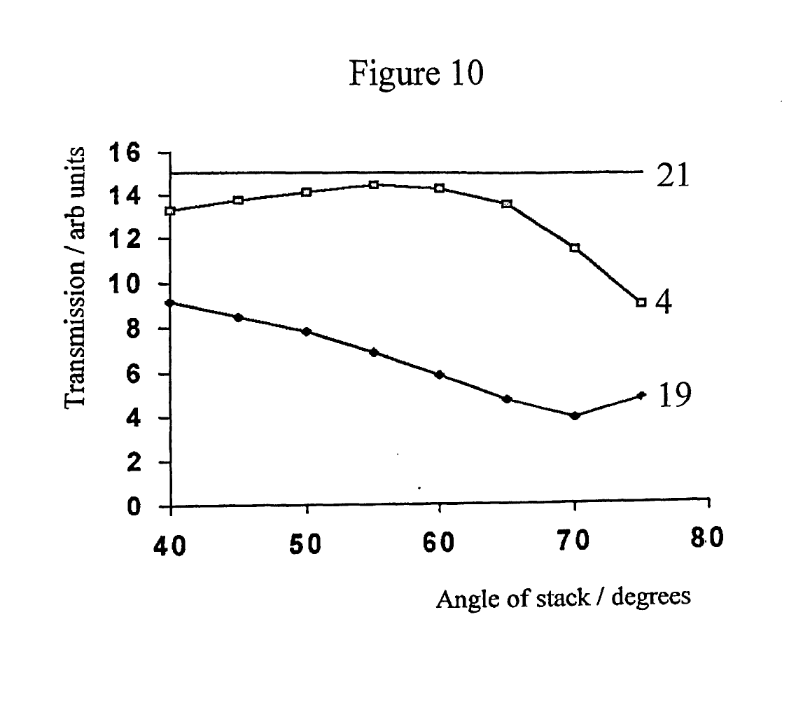

FIG. 10 illustrates the effect of a pre-polariser with the filter of earlier figures;

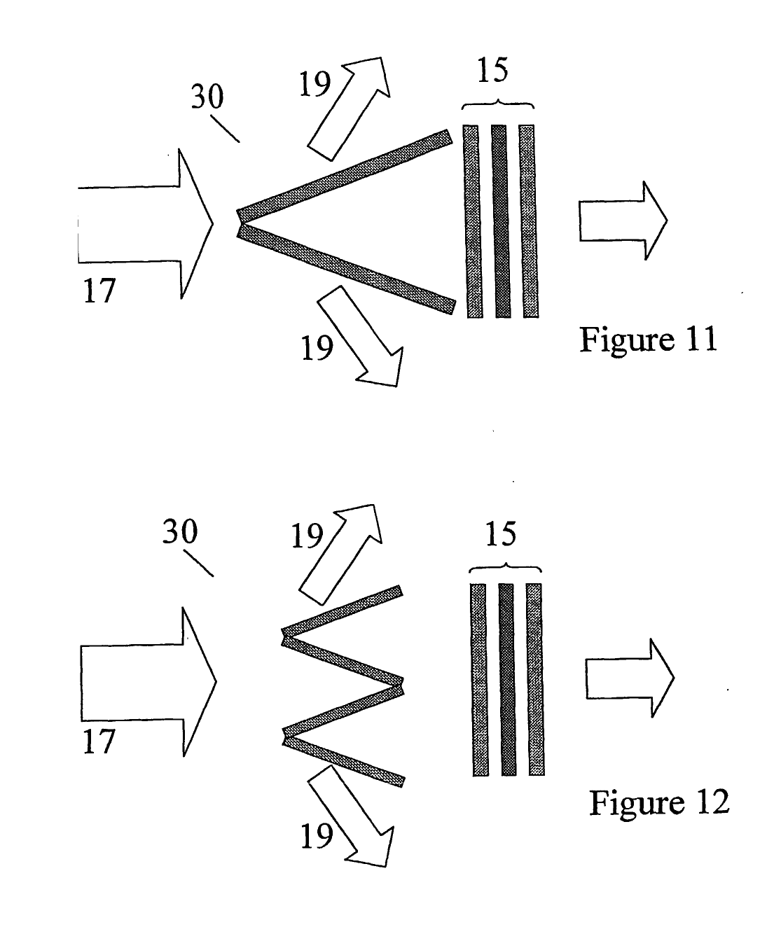

FIGS. 11, 12 and 13 illustrate alternative pre-polariser structures that may be employed with the invention;

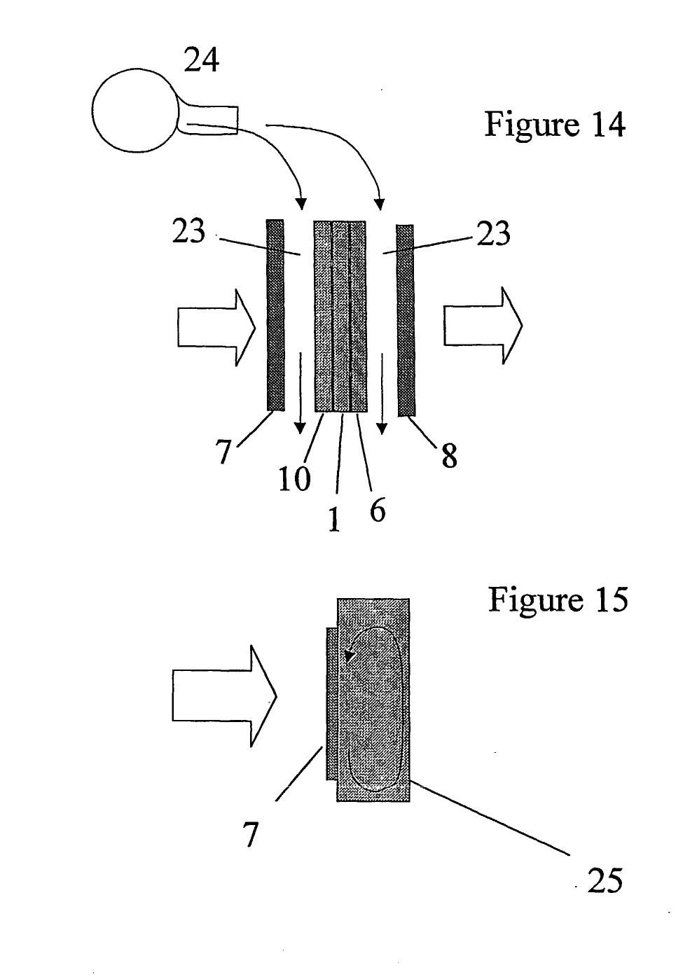

FIG. 14 illustrates how air may be used to cool polarisers in the present invention;

FIG. 15 illustrates how a fluid cell may be used to cool a polariser in the invention;

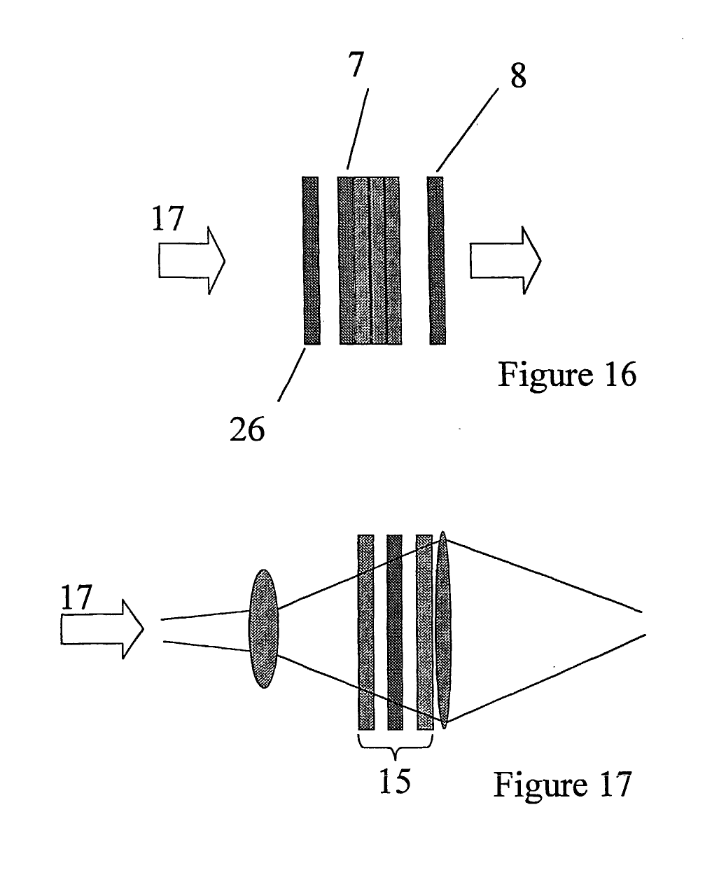

FIG. 16 shows the use of a sacrificial polariser to protect higher quality polarisers in the invention;

FIG. 17 shows how expansion of an incoming beam of illuminating light can control the temperature of a polariser in the invention;

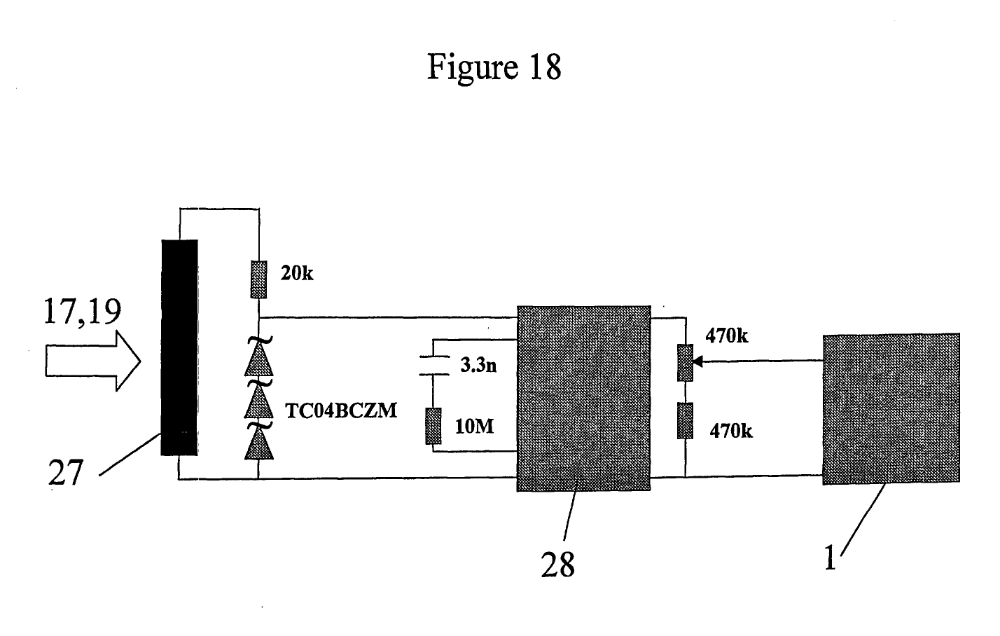

FIG. 18 illustrates a typical low power drive circuit that may be employed with the invention;

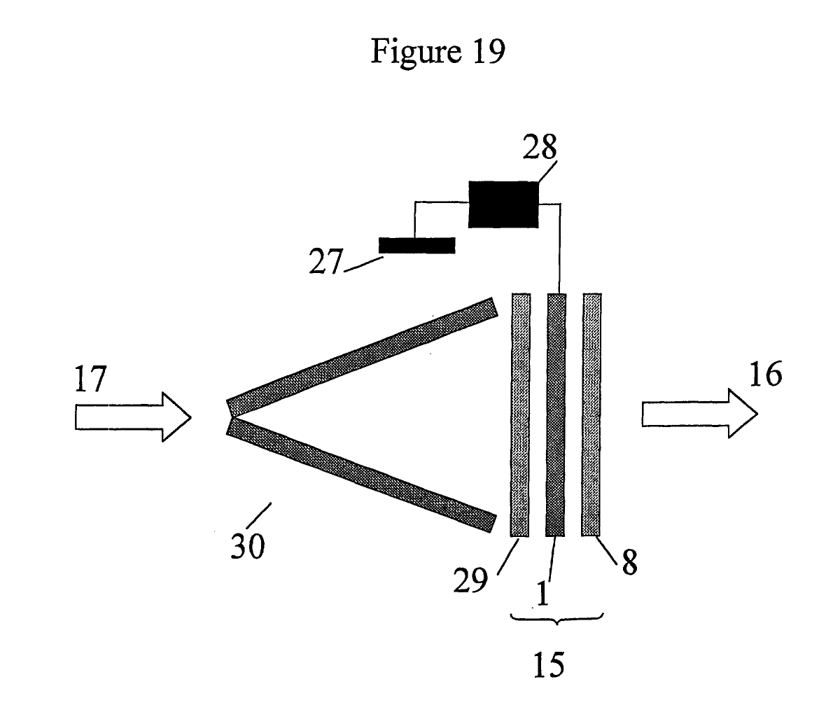

FIG. 19 is a schematic diagram of a filter according to the invention for use in a lighting system; and

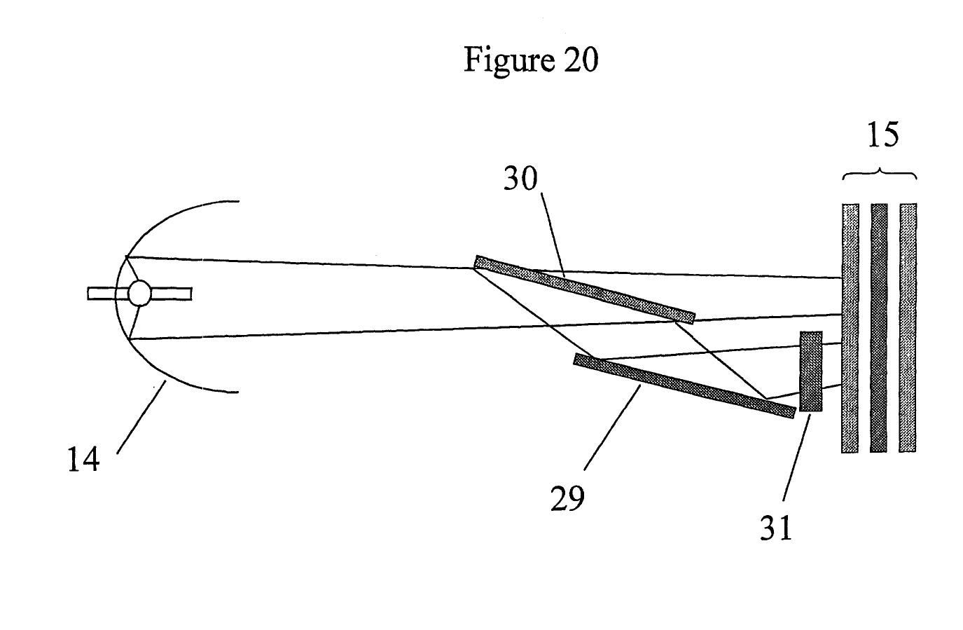

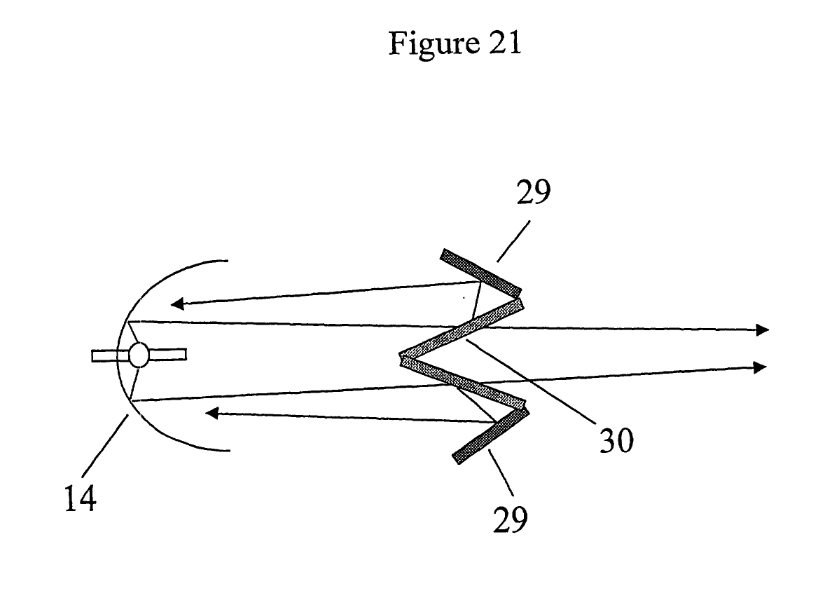

FIGS. 20 and 21 show examples of how the efficiency of a lighting system according to the invention may be increased by recycling the unused polarised light.

Referring to FIG. 1, a twisted nematic liquid crystal display 1 (TN LCD) is conventionally used to provide variable attenuation. The TN LCD 1 comprises a liquid crystal 2 aligned in a cell of two substantially flat parallel glass plates 3. The orientation of the liquid crystal 2 in the cell is such that the molecular axes of the liquid crystal 2 lie in the plane of the cell and form a half pitch of a helix across the cell, such that the molecular axes on opposite sides are perpendicular.

Polarised light 4 entering the cell is guided by the molecular axes of the liquid crystal 2 and light 5 exits from the cell with its polarisation state rotated by 90 degrees. When a sufficient driving voltage is applied across the liquid crystal layer 2 the molecular axes substantially align with the electric field and the polarised light 4 passes through the cell unchanged. Polarisers placed outside the cell 1 with appropriate orientation can therefore cause the cell 1 to go from light to dark or vice versa, on application of a sufficient driving voltage, depending on the orientation of the polarisers.

This well known technology is used to produce monochromatic displays for many applications including digital watches, computers, digital meters, car dashboards and so on.

A more complex filter is illustrated schematically in FIG. 2. Here, a conventional TN LCD 1 is used in combination with a birefringent element 6, pre-polariser 7 and post-polariser 8. Birefringent filters have been known for many years, having first been used in astronomy for the investigation of the spectrum of stars by the astronomer Lyot. They have the property, when appropriately constructed, of allowing a transformation of polarisation to be converted to a change in colour.

The birefringence of a birefringent plate 6 retards one polarisation more than the other, with the relative retardation (and therefore the output polarisation) depending on the birefringence, thickness and wavelength of the light passing through the plate. For any given plate and a fixed input polarisation, the output polarisation depends on the wavelength and therefore, viewed through an analysing polariser, the plate is coloured. If the input polarisation is rotated, this colour changes.

We illustrate this with a detailed example, shown schematically in FIG. 3. Let us assume that a birefringent filter consists of a pre-polariser 7, birefringent plate 6, and post-polariser 8. The pre-polariser 7 has its polarising axis inclined at an adjustable angle 9 to the optical axis of the birefringent plate 6. The post-polariser 8 has its polarising axis inclined at +45 degrees to the optical axis of the birefringent plate 6.

When the adjustable angle 9 is +45 degrees, the polarised light from the pre-polariser is resolved equally into the two principal axes of the birefringent plate 6. On passing through the plate, the two resolved polarisation states undergo a relative phase shift which depends on the plate thickness, the plate birefringence, and the wavelength of the light. The two polarisation states can be represented as:

E_{ordinary}=(Eᵢₙ/\sqrt{2})·exp(−i·Δn·π·t/λ)

and

E_{extraodinary}=(Eᵢₙ/\sqrt{2})·exp(−i·Δn·π·t/λ)

Where Δn is the birefringence, t the plate thickness and λ the wavelength of the light passing through the plate.

When these two polarisation states fall on the post-polariser 8 they are resolved into the principal axis of the post polariser. The output state is therefore given by:

Eₒᵤₜ=(Eᵢₙ/2)exp(−i·Δn·π·t/λ)+(Eᵢₙ/2)exp(i·Δn·π·t/λ)

This equation can be re-expressed as:

Eₒᵤₜ=Eᵢₙ·cos(Δn·π·t/λ)

and the transmitted intensity Iₒᵤₜ is therefore given by:

Iₒᵤₜ=Iᵢₙ cos²(Δn·π·t/λ)

where Iᵢₙ is the incident intensity.

It is clear that for wavelengths which satisfy the equation:

Δn·t=m·λ

where m is any integer, all the power passes through the filter. For wavelengths which satisfy the equation:

Δn·t=(m−½)·λ

no power passes through the filter.

In this way the filter is wavelength selective. For example, if m=2 at 520 nm wavelength (a so-called two-wave birefringent plate) the filter efficiently passes light with 530 nm wavelength (green) but not light with wavelengths of 693 nm (red) and 416 nm (blue).

If the adjustable polariser angle 9 coincides with either of the principal axes of the birefringent plate 6, the polarisation state leaving the birefringent plate 6 is unmodified regardless of wavelength, and is incident on the post-polariser 8 at 45 degrees to its principal axis. Thus half the light is transmitted, without wavelength dependence.

If the adjustable polariser angle 9 is −45 degrees, the light is transmitted according to the equation:

Eₒᵤₜ=Eᵢₙ·sin(Δn·π·t/λ)

and the transmitted intensity Iₒᵤₜ is therefore given by:

Iₒᵤₜ=Iᵢₙ·sin²(Δn·π·t/λ)

where Iᵢₙ the incident intensity.

For the example of a two wave birefringent plate, this means that red and blue are transmitted but green is not, resulting in a magenta transmission colour.

Therefore, for a single birefringent plate 6, rotating the input polarisation by 90 degrees causes the colour to change from one hue, through grey, to the anti-hue. In this example, green would change through grey to magenta. This rotation of input polarisation can be achieved by placing a TN LCD 1 between a pre-polariser 7, now with fixed orientation, and the birefringent plate 6. The same optical effect could be achieved by placing the TN LCD 1 between the birefringent plate 6 and the post-polariser 8.

A single two wavelength plate is preferred for tuneable colour applications because this, in practice, is found to produce the best combination of colour saturation and transmission efficiency, but more complex birefringent networks could, in principle, be used to produce different wavelength filtering and tuning responses.

However, the production of a half-intensity, uncoloured intermediate state is not desirable in many applications for colour tuneable filters. The present invention therefore provides a quarter wave, birefringent plate 10 in combination with the first birefringent plate 6 in order to produce colour tuning, so that the colour for example may change from green through yellow, red and then to magenta.

This improved birefringent filter structure is illustrated in FIG. 4. In this example the quarter wave birefringent plate 10 is placed before the two wave birefringent plate 6 with the principal axes relatively inclined at 45 degrees.

It can be seen that if the adjustable pre-polariser angle 9 is 0 or −90 degrees, the polarising axis of the pre-polariser 7 coincides with the principal axes of the quarter wave plate 10, and the quarter wave plate 10 does not affect the polarisation state passing through it. In this case the light passes unmodified through to the two-wave birefringent plate 6 and is filtered as in the previous example, and the filter produces a green or magenta hue.

If the adjustable pre-polariser angle 9 is arbitrary, the quarter wave plate 10 converts the polarisation state passing into the two-wavelength plate 6 into an elliptical form.

Following the formalism of the previous example, the input polarisation states to the quarter wave plate 10, resolved along the principal axes of the quarter wave plate are:

E_{ordinary}=Eᵢₙ·sin(α)·exp(−i·Δn·π·t/λ)

and

E_{extraordinary}=Eᵢₙ·cos(α)·exp(i·Δn·π·t/λ)

Where Δn is the birefringence, t the plate thickness and λ the wavelength of the light passing through the quarter wave plate. The angle denoted α is the pre-polariser angle 9. In this case the plate is conveniently a quarter wave at the centre of the visible spectrum, λ=530 nm, so

Δn·t=530/4 or Δn·t=λₒ/4

In order in simplify the algebra we make the approximation that λ≈λₒ so that:

E_{ordinary}=Eᵢₙ·sin(α)·(1−i)/\sqrt{2}

and

E_{extraordinary}=Eᵢₙ·cos(α)·(1+i)/\sqrt{2}

These two states are further resolved into the principal axes of the two wave plate 6, so that after the two wave plate the two polarisation states are:

E_{ordinary}=(Eᵢₙ cos α(1+i)/2+Eᵢₙ sin α(1−i)/2)exp(−i·Δn·π·t/λ)

and

E_{extraordinary}=(Eᵢₙ cos α(1+i)/2−Eᵢₙ sin α(1−i)/2)exp(i·Δn·π·t/λ)

When these states reach the post polariser 8 they are further resolved into the polarising axis of the post-polariser 8, so that the transmitted light is given by:

Eₒᵤₜ=E_{extraordinary}/\sqrt{2}+E_{ordinary}/\sqrt{2}

If we re-arrange the equations above we can show that:

(i+1)·cos α+(1−i)·sin α=(1+i)exp(−i·α)

and

(i+1)·cos α−(1+i)·sin α=(1+i)exp(i·α)

and therefore

Eₒᵤₜ=(Eᵢₙ·(1+i)/\sqrt{2})·cos(Δn·π·t/λ−α)

and the transmitted intensity Iₒᵤₜ is therefore given by:

Iₒᵤₜ=Iᵢₙ·cos²(Δn·π·t/λ−α)

where Iᵢₙ is the incident intensity.

From the form of this equation it is clear that as the angle α changes the wavelength of peak transmission changes according to the equation:

Δn·t=(m+α/π)·λ

This equation shows that the transmission of the filter in this form is truly colour tuneable, in that rotation 9 of the pre-polariser 7 (change in α) results directly in a change in peak transmission wavelength, λ.

Therefore, a quarter wave birefringent plate 10 used in combination with a two wave birefringent plate 6 produces colour tuning. Rotating the input polarisation by 90 degrees causes the colour to change from one hue, through a range of hues, to the anti-hue, so that the colour for example may change from green, through yellow, red and then to magenta, or from green, through cyan and blue to magenta depending on the orientation of the components. In this way the undesirable intermediate grey state of the previous example is avoided.

The rotation of input polarisation can be achieved by placing a TN LCD 1 between the pre-polariser 7, now with fixed orientation, and the first birefringent plate 10. The same optical effect could be achieved by placing the TN LCD 1 between the second birefringent plate 6 and the post-polariser 8.

If two TN LCDs 1 are used in series, the polarisation rotation can be 180 degrees. In this way a full sequence of colours, for example green, through yellow, red, magenta, blue, cyan and back to green, can be produced.

FIG. 5 shows an example of such a filter structure. FIG. 5 shows the elements of the filter in series with the principal optical axes indicated. The elements are, in turn, the pre-polariser 7, two wave birefringent plate 6, quarter wave birefringent plate 10, two TN LCDs 1 and the post polariser 8. The two LCDs are typically driven in parallel with the same electrical drive signal.

This filter structure is capable of producing a range of hues as described above, but is limited in that it cannot produce pastel, or unsaturated, colours. A modification to the filter structure shown in FIG. 5 allows these colours to be accessed.

In this second example filter structure the arrangement of the components is slightly different. In this example (shown in FIG. 6), the pre-polariser 7 is followed by a first TN LCD 1, the two wave birefringent plate 6, a quarter wave birefringent plate 10, a second TN LCD 1, and a post-polariser 8. In this arrangement the first TN LCD 1 controls the colour saturation and the second the hue. In this way a wide range of colours can be produced.

The example filter structures shown in FIGS. 4, 5 and 6 have in common the series combination of a high order wave plate (for example a two-wave plate 6) and a quarter wave plate 10 with the principal axes inclined at relative 45 degree rotation

It is clear that this filter structure can be used in the production of LCD information displays, such as advertising signs, computer screens, etc., where it allows colour to be added to a black and white display at low cost with little added manufacturing complexity.

A typical example is shown in FIG. 7, where the invention can be used to advantage. Traditional LCD overhead projector panels have had low optical efficiency and therefore require a high power projector. A projection panel incorporating birefringent colour tuning 11 on an overhead projector 12 can give a factor of three enhancement in the brightness of the projected image 13.

The invention may also be used for example in technical applications where wavelength switching or tuneable filtering is required, such as in multiplexed fibre optic transmitters and receivers, which typically operate outside the range of visible illumination.

The invention also finds application in illumination systems where the colour of a lamp may be continuously changed by electronic control. The invention can be applied to any illumination system which has a directed light source, for example spot lamps, torches, fibre optic illuminators and endoscopes.

An example of this is illustrated in FIG. 8, where a conventional spot luminaire 14 is filtered by a birefringent colour filter 15 and produces a range of illumination colours 16.

In application to luminaires 14, the heat produced by the luminaire 14 in the form of radiation can be damaging to the components of the filter 15 and there is, therefore in addition, provided a pre-polariser 30 which diverts the unwanted polarisation and the infra-red light away from the TN LCD 1 (FIG. 9). This uses the well known Brewster effect, where unpolarised light 17 incident on a dielectric 18 becomes partially polarised in transmission 4, the unwanted light 19 being substantially reflected from the plates 18. The use of a number of dielectric plates 18, which may, for example, be cut, transparent, plastic sheeting, allows the light from the lamp 17 to be strongly polarised before reaching the filter without excessively heating the optical components of the filter. A second, dichroic pre-polariser 20 is used to ensure that a high degree of polarisation is maintained for angles away from the Brewster angle.

The effect of this pre-polariser component is demonstrated in FIG. 10 where three plates of polycarbonate 18 have been used to polarise a beam 17. The transmission of the required polarisation 4 and the unused polarisation 19 is shown plotted against the angle of inclination of the stack. The power in a polarisation without the stack present is also plotted for comparison 21.

By modifying the configuration of the pre-polariser 30 as shown in FIGS. 11 and 12 a similar heat shielding effect can be achieved. Since the same surface area can be provided with reduced depth of plate when multiple portions are used, as in the “V” and “W” configurations illustrated, the resultant pre-polariser 30 will be less bulky than one using a single plate and will, therefore, contribute to a more compact filter.

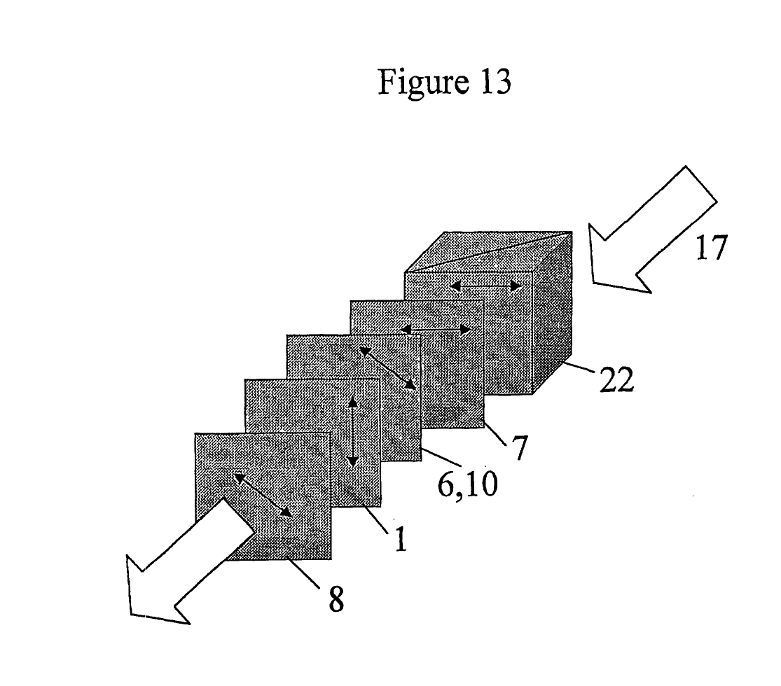

An alternative to these “Brewster plates” 30 is shown in FIG. 13. In this diagram, the Brewster plates 30 (and possibly the absorbing polariser 20) are replaced by a commercially available polarising beam splitter cube 22.

Further steps may be taken to control the temperature of the heat sensitive polarisers 7 and to make the polarisers heat resistant. FIG. 14 illustrates a scheme whereby the polarisers 7,8 are not laminated to the waveplates 6,10 and LCD 1: Air gaps 23 are retained adjacent to the polarisers 7, 8 and these gaps 23 are continuously flushed with air driven by a fan 24 to maintain a high level of thermal transfer between the polariser and the air. A similar effect is achieved by the configuration illustrated in FIG. 15. A fluid cell 25 is provided adjacent to the polariser 7. Convection currents in the fluid help to redistribute the heat into the greater thermal mass of the cell. The fluid cell 25 may be modified such that fins are attached to increase its surface area to enhance air cooling.

FIG. 16 shows the use of a sacrificial polariser 26. This polariser 26 may be of reduced quality but increased heat resistance in order to protect the higher quality heat sensitive polarisers 7 which comprise the optical filter. In a lighting system, such a disposable polariser 26 may have a similar life to that of the bulb and could be attached to the light source to form a removable unit which can easily be replaced when required.

Another means of controlling the temperature of the polariser 7 is to expand the incident beam 17 from the luminaire 14 as it passes through the colour filter 15 as illustrated in FIG. 17.

In the filter of the invention, low power consumption and lack of moving parts means that the filter 15 is useful for applications where power is at a premium. This also means that, in lighting systems, the filter 15 can be powered via a photosensitive cell, such as an array of photodiodes 27 (commonly referred to as a solar cell) which collects stray light from the lamp 17, or conveniently, light rejected 19 by pre-polarising elements 30. In addition to the above benefits another advantage of the filter of the invention over known motorised colour filter systems is that it is less bulky, more reliable and does not require a relatively large additional power supply and built-in control and power wiring. A typical low power drive circuit that may be employed in a system according to the invention is shown in FIG. 18 where light is converted to energy by the solar cell 27 which passes through drive circuitry 28 to the LCD 1.

In place of a solar cell 28, any device capable of producing electricity from heat or light could be used, for example a thermopile or pyro-electric device.

A filter 15 for use in lighting, shown schematically in FIG. 19, can therefore be self contained, having the optical elements of Brewster pre-polariser 30, birefringent network 29, TN LCD 1, and post-polariser 8. The TN LCD 1 is driven by power derived from a solar cell 27 and controlled by receiver 28 detecting signals from a remote transmitter. In this way, incoming white light 17 from a separate luminaire can be filtered to provide coloured light 16 on demand.

The efficiency of such a lighting system may be improved by recycling the light which has been rejected 19 by the pre-polarising elements 30. FIG. 20 illustrates the use of a reflector 29 to pass the light rejected by the pre-polariser 30 through the filter 15. A half wave plate 31 is used to convert this reflected light to the same polarisation as the remainder of the light entering the filter 15.

A further example of improving the efficiency of a lighting system is illustrated in FIG. 21. Reflectors 29 are positioned in such a way that the rejected light 19, from the pre-polariser 30, is returned to the light source 14 where it will be depolarised and re-emitted towards the filter 15 (not shown in FIG. 21).

1. A tuneable optical filter having a variable wavelength transmittance comprising:
a pre-polariser;
a post-polariser;
a birefringent plate positioned between the pre-polariser and the post-polariser;
a twisted nematic liquid crystal cell (TN LCD) positioned between the pre-polariser and the post-polariser the TN LCD being controlled, in use, to tune the filter; and
a quarter wave plate positioned adjacent the birefringent plate; wherein one of the pre-polariser and the post-polariser has its polarising axis inclined at substantially 45° to the optical axis of the birefringent plate; and further comprising a second TN LCD wherein the birefringent plate is positioned between the first and second TN LCDs.

2. An optical filter according to claim 1, further comprising a further TN LCD in series with the first TN LCD.

3. An optical filter according to any one of the preceding claims, wherein the pre-polariser comprises at least one sheet of dielectric material inclined at the Brewster angle to incoming light.

4. An optical filter according to claim 3, wherein the pre-polariser also comprises a dichroic polariser.

5. An optical filter according to claim 3 or claim 4, wherein the dielectric material is configured in a “V” shape, a “W” shape or other successive joined “V” shapes, wherein portions of the dielectric material are inclined at the Brewster angle to incoming light.

6. An optical filter according to any one of the preceding claims, wherein the birefringent plate is a two wave plate.

7. An optical filter according to any one of the preceding claims, wherein the pre-polariser comprises a heat resistant pre-polariser.

8. An optical filter according to any one of the preceding claims, wherein at least one of the pre-polariser and the post-polariser is wavelength independent.

9. An optical filter according to any one of the preceding claims, wherein the birefringent plate is wavelength independent in terms of amplitude modulation.

10. A lighting system comprising:
a light source; and
an optical filter according to any one of the preceding claims.

11. A lighting system according to claim 10, further comprising selecting means for receiving, in use, a colour selection from a user and driving the filter to provide the desired colour for the lighting system.

12. A lighting system according to claim 10 or claim 11, when dependent on claim 9, wherein the light source and the heat resistant pre-polariser form a removable unit.

13. A lighting system according to any of claim 10 to claim 12, further comprising a photocell, wherein the photocell receives light from the light source and converts this light to energy, to drive the optical filter, in use.
